(19) United States
(12) Patent Application Publication
(10) Pub. No.: US 2008/0282511 A1
(43) Pub. Date: Nov. 20, 2008

(54) Composite rope structures and systems and methods for terminating composite rope structures

(76) Inventors: Chia-Te Chou, Bellingham, WA (US); Liangfeng Sun, Bellingham, WA (US)

Correspondence Address: SCHACHT LAW OFFICE, INC., SUITE 202, 2801 MERIDIAN STREET, BELLINGHAM, WA, 98225-2412, US

(21) Appl. No.: 12/154,073

(22) Filed: May 19, 2008

Related U.S. Application Data
(60) Provisional application No. 60/931,089, filed on May 19, 2007.

(51) Int. Cl. F16G 11/00

(52) U.S. Cl. 24/135 R

(57) ABSTRACT

A termination assembly for a composite rope structure comprising an end comprises a distal connection member and a proximal connection member. The distal connection member defines a first threaded surface and a working portion, where the working portion is adapted to be connected to a structure. The proximal connection member defines a second threaded surface, an internal surface, and a proximal opening. The first and second threaded surfaces are configured to engage each other to detachably attach the distal connection member and the proximal connection member. The internal surface of the proximal connection member is configured to engage the end of the composite rope structure to secure the composite rope structure relative to the proximal connection member.

### RELATED APPLICATIONS

This application claims priority of U.S. Provisional Patent Application Ser. No. 60/931,089 filed May 19, 2007, the contents of which are incorporated herein by reference.

### TECHNICAL FIELD

The present invention relates to composite rope structures and to systems and methods for terminating composite rope structures.

### BACKGROUND

The need often exists for a rope structure to be arranged in tension between two objects. The characteristics of a given type of rope structure determine whether that type of rope structure is suitable for a specific intended use. Characteristics of rope structures include breaking strength, elongation, flexibility, weight, and surface characteristics such as abrasion resistance and coefficient of friction. Additionally, environmental factors such as heat, cold, moisture, UV light, abrasion, and the like may affect the characteristics of a rope structure.

The intended use of a rope thus typically determines the acceptable range for each characteristic of the rope. The term “failure” as applied to rope will be used herein to refer to a rope being subjected to conditions beyond the acceptable range associated with at least one rope characteristic.

Ropes made of composite materials have been proposed. Ropes made of composite materials have characteristics that are optimized for certain environments.

However, conventional systems and methods for terminating conventional rope structures may not be appropriate for terminating ropes made of composite materials. The need thus exists for terminating systems and methods for terminating rope structures made of composite materials.

### SUMMARY

The present invention may be embodied as a termination assembly for a composite rope structure comprising an end. The termination assembly comprises a distal connection member and a proximal connection member. The distal connection member defines a first threaded surface and a working portion, where the working portion is adapted to be connected to a structure. The proximal connection member defines a second threaded surface, an internal surface, and a proximal opening. The first and second threaded surfaces are configured to engage each other to detachably attach the distal connection member and the proximal connection member. The internal surface of the proximal connection member is configured to engage the end of the composite rope structure to secure the composite rope structure relative to the proximal connection member.

The present invention may also be embodied as a terminated composite rope structure comprising a composite rope structure comprising an end and a termination assembly for connecting the end of the composite rope structure to a structural member. The termination assembly comprises a distal connection member and a proximal connection member. The distal connection member defines a first threaded surface and a working portion, where the working portion is adapted to be connected to the structure. The proximal connection member defines a second threaded surface, an internal surface, and a proximal opening. The first and second threaded surfaces are configured to engage each other to detachably attach the distal connection member and the proximal connection member. The internal surface of the proximal connection member is configured to engage the end of the composite rope structure to secure the composite rope structure relative to the proximal connection member.

The present invention may also be embodied as a method of terminating a composite rope structure comprising the following steps. A distal connection member is provided, where the distal connection member defines a first threaded surface and a working portion adapted to be connected to the structure. A proximal connection member is provided, where the proximal connection member defines a second threaded surface, an internal surface, and a proximal opening. An end portion of the composite rope structure is arranged within the proximal opening of the proximal connection member. The internal surface of the proximal connection member is configured to engage the end of the composite rope structure to secure the composite rope structure relative to the proximal connection member. The first and second threaded surfaces are engaged to detachably attach the distal connection member and the proximal connection member.

### BRIEF DESCRIPTION OF THE DRAWINGS

FIG. 1 is a perspective view of a first example terminated composite rope structure constructed in accordance with, and embodying, the principles of the present invention;

FIG. 2A is a side elevation view of a distal termination member of the first example terminated rope structure;

FIG. 2B is a section view of the distal termination member;

FIG. 3A is a side elevation view of a proximal termination member of the first example terminated rope structure;

FIG. 3B is a section view of the proximal termination member;

FIG. 4A is a side elevation view of an inner termination member of the first example terminated rope structure;

FIG. 4B is a section view of the inner termination member;

FIG. 5 is a side elevation view of a first step of a first example process of assembling the first example terminated rope structure;

FIG. 6 is a side elevation view of a second step of the first example process of assembling the first example terminated rope structure;

FIG. 7 is a side elevation view of a third step of the first example process of assembling the first example terminated rope structure;

FIG. 8 is a section view of the first example terminated rope structure;

FIG. 9 is a section view of a second example terminated rope structure of the present invention;

FIG. 10 is a section view of a third example terminated rope structure of the present invention;

FIG. 11 is a section view of a fourth example terminated rope structure of the present invention;

FIG. 12A is a section view of a fifth example terminated rope structure of the present invention;

FIG. 12B is a section view of the fifth example terminated rope structure taken along lines 12B-12B in FIG. 12A.

FIG. 13A is a section view of the sixth example terminated rope structure of the present invention; and

FIG. 13B is a section view of the sixth example terminated rope structure taken along lines 13B-13B in FIG. 13A.

### DETAILED DESCRIPTION

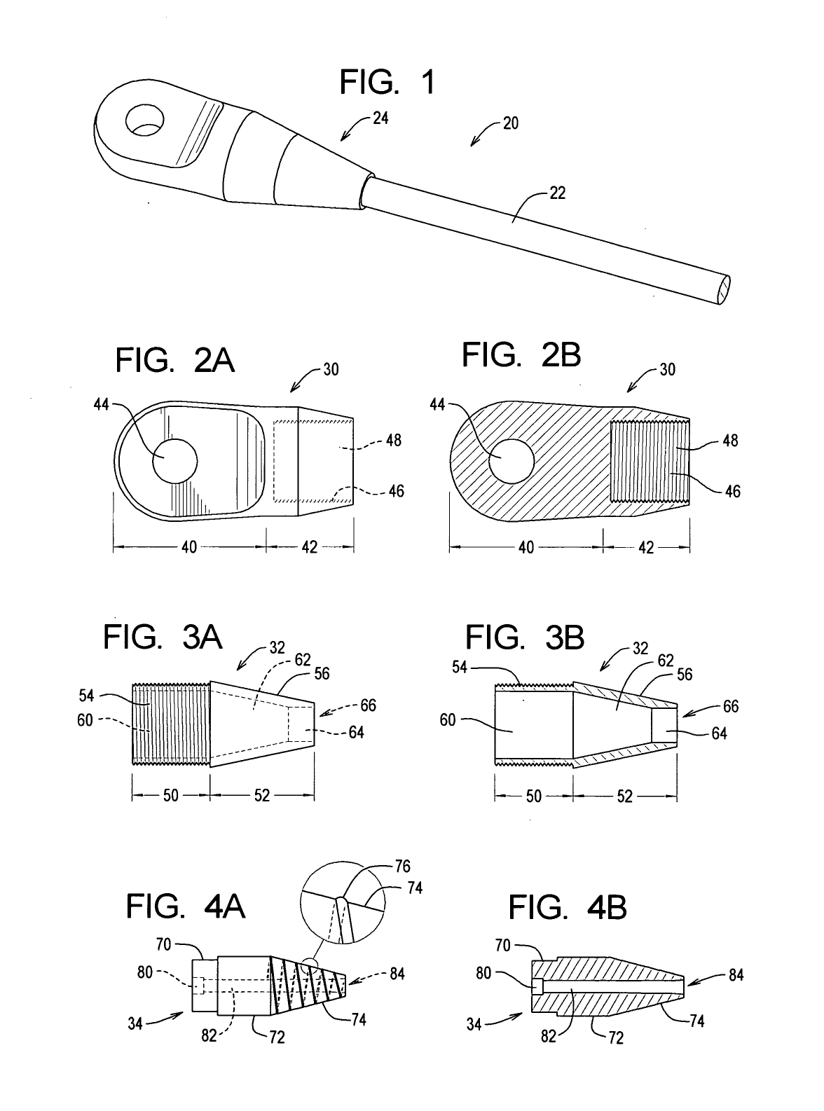

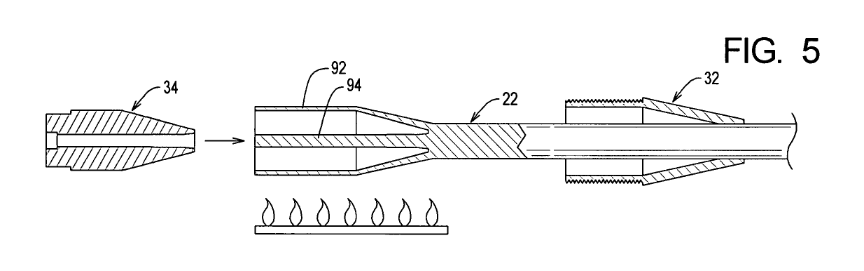

Referring initially to FIG. 1 of the drawing, depicted therein is a first example terminated composite rope structure 20 constructed in accordance with, and embodying, the principles of the present invention. The terminated composite rope structure 20 comprises a composite rope member 22 and a termination assembly 24. The termination assembly 24 comprises a distal termination member 30 (FIGS. 2A and 2B), a proximal termination member 32 (FIGS. 3A and 3B), and an internal termination member 34 (FIGS. 4A and 4B).

The composite rope member 22 comprises a plurality of fibers embedded within a matrix of resin and will be described in further detail below. In addition, examples of composite rope members in connection with which the present invention may be used are described in the Applicant's copending U.S. Patent Application Ser. Nos. 60/930,853 (Attorney Matter No. P215308) and 60/931,088 (Attorney Matter No. P215421).

The example distal termination member 30 comprises a working portion 40 and a distal connecting portion 42. The example working portion 40 comprises an eyelet opening 44 that may be connected to a structural member (not shown). The working portion 40 may take forms other than that depicted in the drawing depending upon the environment in which the composite rope structure 20 is used and/or the nature of the structural member to which the composite rope structure 20 is to be attached. For example, the working portion may take the form of a hook, a pulley, a pin, or the like. The example distal connecting portion 42 comprises a threaded surface 46. The example threaded surface 46 is an internal surface surrounding a cavity 48.

The example proximal connection member 32 comprises a proximal connecting portion 50 and a transition portion 52. The proximal connecting portion 50 comprises a threaded surface 54 and a transition surface 56. The threaded surface 54 and transition surface 56 are external surface of the proximal connection member 32. The proximal connecting member 32 further comprises a distal surface 60, a first engaging surface 62, and a throat surface 64. The distal surface 60, first engaging surface 62, and throat surface 64 of the example proximal connecting member 32 are internal surfaces that define a proximal opening 66.

The example internal connection member 34 comprises a step surface 70, an intermediate surface 72, and a second engaging surface 74. An optional rib projection 76 extends from the second engaging surface 74. The example internal connection member 34 further comprises a head surface 80 and a shaft surface 82. The head surface 80 and shaft surface 82 are internal surfaces that define an internal opening 84 in the internal connection member 34.

The internal threaded surface 46 on the distal connection member 30 is sized and dimensioned to threadingly engage the external threaded surface 54 on the proximal connection member 32. The internal connection member 34 fits within the proximal opening 66 in the proximal connection member 32 such that the distal surface 60 of the proximal connection member 32 receives the intermediate surface 72 on the internal connection member 34 and the first engaging surface 62 of the proximal connection member 32 receives the second engaging surface 74 of the internal connection member 34.

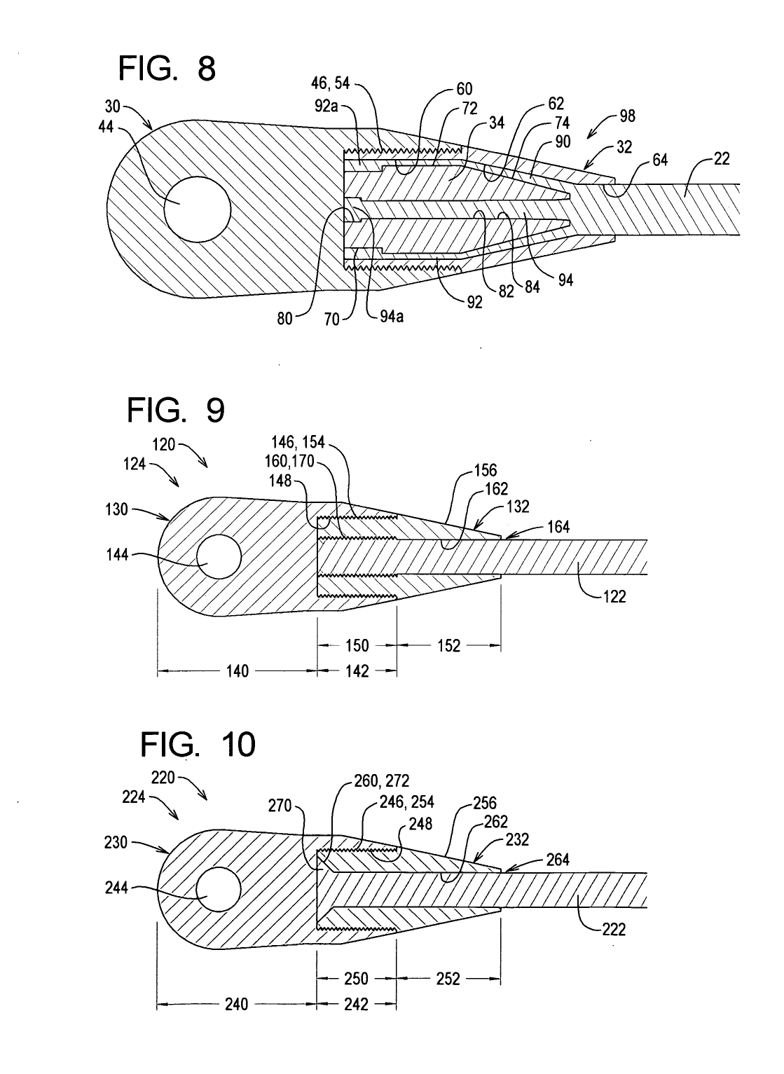

When the internal connection 34 is within the proximal opening 66, a continuous gap 90 is formed between the surfaces 60 and 72 and between the surfaces 62 and 74. When the terminated composite rope structure 20 is formed (see, e.g., FIGS. 7 and 8), the continuous gap 90 is substantially filled by a first portion 92 of the composite rope structure 22 and the internal opening 84 is substantially filled by a second portion 94 of the composite rope structure 22.

To use the termination assembly 24 to terminate the composite rope member 22, the proximal connection member 32 is preferably first placed over the end of the rope member 22 (FIG. 5).

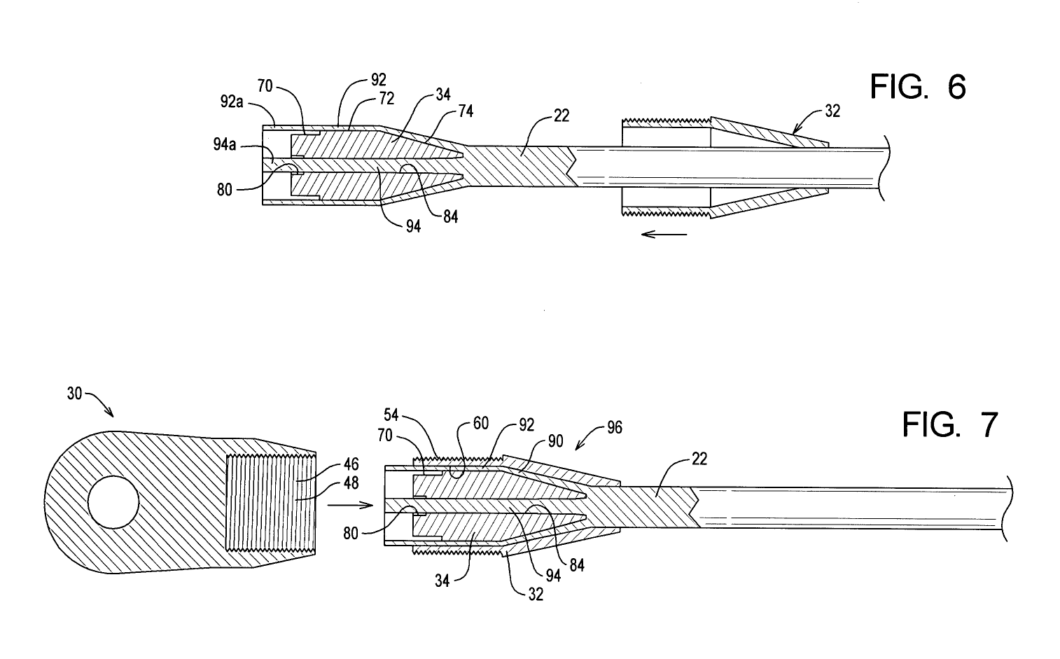

The rope member 22 is then separated into the first and second portions 92 and 94 and the internal connection member 34 is displaced until the second rope portion 94 extends through the internal opening 84; at this point, the first rope portion 92 extends over the step surface 70, the intermediate surface 72, and the second engaging surface 74 as shown in FIG. 6. In the example depicted in FIG. 6, first and second extra portions 92a and 94a of the first and second rope portions 92 and 94, respectively, extend beyond the internal connection member 32.

The proximal connection member 32 is then displaced towards the internal connection member 34 as shown in FIG. 6 to form a first intermediate structure 96 defining the gap 90. The total cross-sectional areas of the gap 90 and the internal opening 84 at any point along the longitudinal axis of the first intermediate structure 96 is predetermined to be substantially the same as the total cross-sectional area of the rope member 22. Accordingly, when the first intermediate structure 96 has been formed, the gap 90 is substantially completely occupied by the first rope portion 92 and the internal opening 84 is substantially completely occupied by the second rope portion 94.

After the intermediate structure 96 has been formed, the distal connection member 30 is displaced towards the proximal connection member 30 until the threaded surfaces 46 and 54 engage each other. At this point, rotation of the distal connection member 30 and/or the proximal connection member 32 relative to each other causes further displacement of the distal connection member 30 towards the proximal connection member 32.

As the distal connection member 30 tightens against the proximal connection member 32, a second intermediate structure 98 is formed. When the second intermediate structure 98 is formed, the first extra portion 92a is pressed against the step surface 70 and the second extra portion 94a is pressed against the head surface 80 as shown in FIG. 8.

At any point in the process of forming the terminated composite rope structure 20, heat may be applied to affect the characteristics of the resin matrix. If the rope member 22 is too rigid, heat may be applied below the cure temperature to render the resin matrix more plastic or malleable. After the second intermediate structure 98 has been formed, heat is applied above the cure temperature to cause the resin matrix to solidify, thereby forming the terminated composite rope structure 20.

The rope member 22 may be a monolithic structure of fibers within a resin matrix, but will more likely be formed by a combination of subcomponents. For example, the fibers and resin matrix can be combined in a first subcomponent that may be referred to as a yarn. The first subcomponent, or yarn, is typically combined other subcomponents to form a second subcomponent that may be referred to as a strand. The strand may be used as a complete rope member or, more typically, is combined with other subcomponents to form the complete composite rope member 22.

In the case where yarns are combined to form strands and strands are combined to form the composite rope member 22, the yarns are composite structures comprising fibers and resin. The fibers are primarily responsible for the strength properties thereof under tension loads. The resin forms a matrix of material that surrounds the fibers and transfers loads between the fibers. The resin matrix further protects the fibers from the surrounding environment. As examples, the resin matrix can be formulated to protect the fibers from heat, UV light, abrasion, and other external environmental factors.

The example resin portion of the impregnated yarns exists in an uncured state and a cured state. In the uncured state, the resin material is flexible, and the matrix allows the yarns to be bent, twisted, and the like. In general, the resin matrix becomes more plastic or malleable when heated, up to a cure temperature. Above the cure temperature, the resin matrix cures and becomes substantially more rigid. The properties of the resin matrix can be adjusted for manufacturing convenience and/or for a particular intended operating environment of the final composite rope structure.

As a first example, yarns forming the rope structure 22 comprise approximately 90% by weight of fibers and approximately 10% by weight of resin. The fibers may be in a first range of substantially between 85% and 95% by weight of the yarn but in any event should be within a second range of substantially between 70% and 98% by weight of the yarn. The resin may be in a first range of substantially between 5% and 15% by weight of the yarn but in any event should be within a second range of substantially between 2% and 30% by weight of the yarn.

As a second example, yarns forming the rope structure 22 comprise approximately 80% by weight of fibers and approximately 20% by weight of resin. The fibers may be in a first range of substantially between 75% and 90% by weight of the yarn but in any event should be within a second range of substantially between 50% and 95% by weight of the yarn. The resin may be in a first range of substantially between 10% and 25% by weight of the yarn but in any event should be within a second range of substantially between 5% and 50% by weight of the yarn.

The example fibers are glass fibers but may be one or a combination of carbon fibers, aramid fibers, polyester fibers, PBO, PBI, Vectran, HMPE, basalt, and ceramic fibers. The resin is thermoplastic polyurethane, but other thermoplastic materials such as polyesters and mixtures of polyurethane and polyesters may also be used. The resin may also be a thermoplastic and/or thermosetting resin system. Other suitable thermoplastic materials include polyester, polyethylene, polypropylene, nylon, PVC, and mixtures thereof.

Turning now to FIG. 9 of the drawing, depicted therein is a second example terminated composite rope structure 120. The terminated composite rope structure 120 comprises a rope member 122 and a termination assembly 124. The termination assembly 124 comprises a distal termination member 130 and a proximal termination member 132.

The distal termination member 130 comprises a working portion 140 and a distal connecting portion 142. The example working portion 140 comprises an eyelet opening 144 that may be connected to a structural member (not shown). Again, the working portion 140 may take forms other than that depicted in the drawing depending upon the environment in which the composite rope structure 120 is used and/or the nature of the structural member to which the composite rope structure 120 is to be attached. The example distal connecting portion 142 comprises a distal threaded surface 146. The example distal threaded surface 146 is an internal surface surrounding a cavity 148.

The example proximal connection member 132 comprises a proximal connecting portion 150 and a transition portion 152. The proximal connecting portion 150 comprises a first proximal threaded surface 154 and a transition surface 156. The first proximal threaded surface 154 and transition surface 156 are external surfaces of the proximal connection member 132. The proximal connecting member 132 further comprises a second proximal threaded surface 160 and a shaft surface 162. The second proximal threaded surface 160 and shaft surface 162 of the example proximal connecting member 132 are internal surfaces that define a proximal opening 164.

Formed on the rope member 122 is a rope threaded surface 170. The rope threaded surface 170 may be preformed on the rope member 122. If the rope threaded surface 170 is preformed, at least the threaded end of the rope member 122 is at least partly cured such that the rope threaded surface 170 holds its threaded shape. Alternatively, the uncured rope member 122 may be force threaded into the proximal opening 164 such that the second proximal threaded surface 160 bites into the rope member and then at least the threaded end portion of the rope member 122 is at least partly cured such that the rope threaded surface 170 holds its threaded shape.

To form the terminated composite rope structure 120, the rope threaded surface 170 is engaged with the second proximal threaded surface 160 to join the proximal connection member 132 to the rope member 122. The distal termination member 130 is then displaced such that the distal threaded surface 146 engages the first proximal threaded surface 154 to connect the distal termination member 130 to the proximal termination member 132.

Turning now to FIG. 10 of the drawing, depicted therein is a third example terminated composite rope structure 220. The terminated composite rope structure 220 comprises a rope member 222 and a termination assembly 224. The termination assembly 224 comprises a distal termination member 230 and a proximal termination member 232.

The distal termination member 230 comprises a working portion 240 and a distal connecting portion 242. The example working portion 240 comprises an eyelet opening 244 that may be connected to a structural member (not shown). Again, the working portion 240 may take forms other than that depicted in the drawing depending upon the environment in which the composite rope structure 220 is used and/or the nature of the structural member to which the composite rope structure 220 is to be attached. The example distal connecting portion 242 comprises a distal threaded surface 246. The example distal threaded surface 246 is an internal surface surrounding a cavity 248.

The example proximal connection member 232 comprises a proximal connecting portion 250 and a transition portion 252. The proximal connecting portion 250 comprises a proximal threaded surface 254 and a transition surface 256. The proximal threaded surface 254 and transition surface 256 are external surfaces of the proximal connection member 232. The proximal connecting member 232 further comprises a proximal canted surface 260 and a shaft surface 262. The proximal canted surface 260 and shaft surface 262 of the example proximal connecting member 232 are internal surfaces that define a proximal opening 264.

Formed on the rope member 222 is a rope head portion 270 defining a rope canted surface 272. The rope head portion 270 may be preformed on the rope member 222. If the rope head portion 270 is preformed, at least the head portion 270 of the rope member 222 is at least partly cured such that the rope head portion 270 holds its threaded shape. Alternatively, the uncured rope member 222 may be forced into the proximal opening 264 such that head portion 270 is formed and then at least the head portion of the rope member 222 is at least partly cured such that the rope head 270 holds the shape of the canted surface 272.

To form the terminated composite rope structure 220, the rope canted surface 272 is engaged with the proximal canted surface 260 to join the proximal connection member 232 to the rope member 222. The distal termination member 230 is then displaced such that the distal threaded surface 246 engages the first proximal threaded surface 254 to connect the distal termination member 230 to the proximal termination member 232.

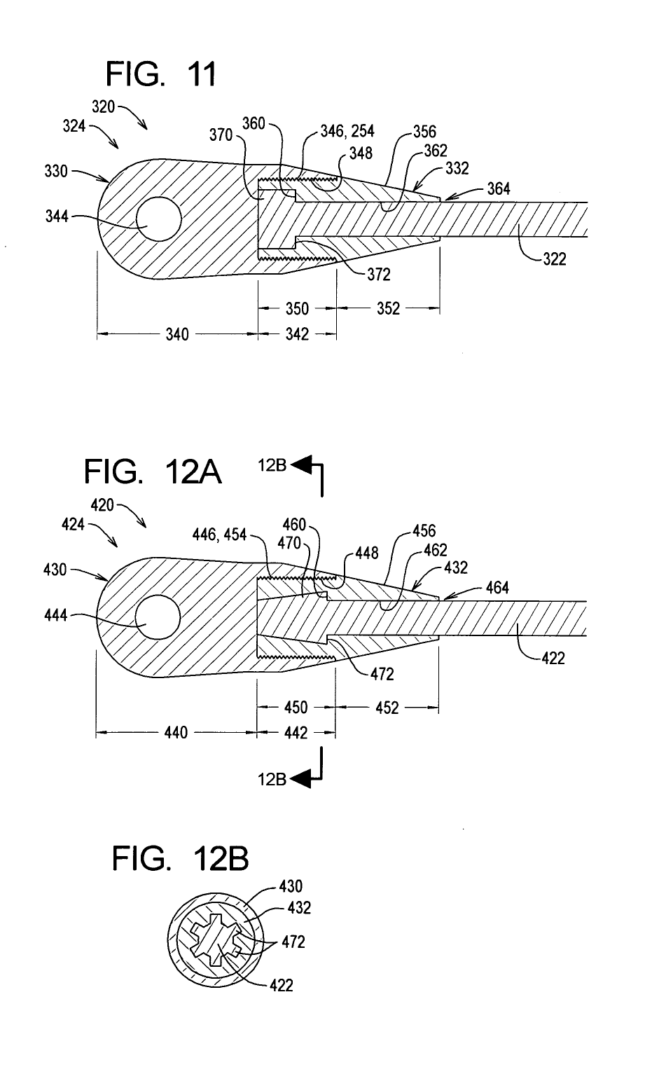

Turning now to FIG. 11 of the drawing, depicted therein is a fourth example terminated composite rope structure 320. The terminated composite rope structure 320 comprises a rope member 322 and a termination assembly 324. The termination assembly 324 comprises a distal termination member 330 and a proximal termination member 332.

The distal termination member 330 comprises a working portion 340 and a distal connecting portion 342. The example working portion 340 comprises an eyelet opening 344 that may be connected to a structural member (not shown). Again, the working portion 340 may take forms other than that depicted in the drawing depending upon the environment in which the composite rope structure 320 is used and/or the nature of the structural member to which the composite rope structure 320 is to be attached. The example distal connecting portion 342 comprises a distal threaded surface 346. The example distal threaded surface 346 is an internal surface surrounding a cavity 348.

The example proximal connection member 332 comprises a proximal connecting portion 350 and a transition portion 352. The proximal connecting portion 350 comprises a proximal threaded surface 354 and a transition surface 356. The proximal threaded surface 354 and transition surface 356 are external surfaces of the proximal connection member 332. The proximal connecting member 332 further comprises a proximal radial surface 360 and a shaft surface 362. The proximal radial surface 360 and shaft surface 362 of the example proximal connecting member 332 are internal surfaces that define a proximal opening 364.

Formed on the rope member 322 is a rope head portion 370 defining a rope radial surface 372. The rope head portion 370 may be preformed on the rope member 322. If the rope head portion 370 is preformed, at least the head portion 370 of the rope member 322 is at least partly cured such that the rope head portion 370 holds its substantially cylindrical shape. Alternatively, the uncured rope member 322 may be forced into the proximal opening 364 such that head portion 370 is formed and then at least the head portion of the rope member 322 is at least partly cured such that the rope head 370 holds the shape of the radial surface 372.

To form the terminated composite rope structure 320, the rope radial surface 372 is engaged with the proximal radial surface 360 to join the proximal connection member 332 to the rope member 322. The distal termination member 330 is then displaced such that the distal threaded surface 346 engages the first proximal threaded surface 354 to connect the distal termination member 330 to the proximal termination member 332.

Turning now to FIGS. 12A and 12B of the drawing, depicted therein is a fifth example terminated composite rope structure 420. The terminated composite rope structure 420 comprises a rope member 422 and a termination assembly 424. The termination assembly 424 comprises a distal termination member 430 and a proximal termination member 432.

The distal termination member 430 comprises a working portion 440 and a distal connecting portion 442. The example working portion 440 comprises an eyelet opening 444 that may be connected to a structural member (not shown). Again, the working portion 440 may take forms other than that depicted in the drawing depending upon the environment in which the composite rope structure 420 is used and/or the nature of the structural member to which the composite rope structure 420 is to be attached. The example distal connecting portion 442 comprises a distal threaded surface 446. The example distal threaded surface 446 is an internal surface surrounding a cavity 448.

The example proximal connection member 432 comprises a proximal connecting portion 450 and a transition portion 452. The proximal connecting portion 450 comprises a proximal threaded surface 454 and a transition surface 456. The proximal threaded surface 454 and transition surface 456 are external surfaces of the proximal connection member 432. The proximal connecting member 432 further comprises a proximal radial surface 460 and a shaft surface 462. The proximal radial surface 460 and shaft surface 462 of the example proximal connecting member 432 are internal surfaces that define a proximal opening 464.

Formed on the rope member 422 are rope fin portions 470 each defining a rope radial surface 472. The rope fin portions 470 may be preformed on the rope member 422. If the rope fin portions 470 are preformed, at least the fin portions 470 of the rope member 422 is at least partly cured such that the rope fin portions 470 hold their shape. Alternatively, the uncured rope member 422 may be forced into the proximal opening 464 such that fin portions 470 are formed and then at least the fin portions of the rope member 422 are at least partly cured such that the rope fin portions 470 hold the shape of the radial surfaces 472.

To form the terminated composite rope structure 420, the rope radial surface 472 is engaged with the proximal radial surface 460 to join the proximal connection member 432 to the rope member 422. The distal termination member 430 is then displaced such that the distal threaded surface 446 engages the first proximal threaded surface 454 to connect the distal termination member 430 to the proximal termination member 432.

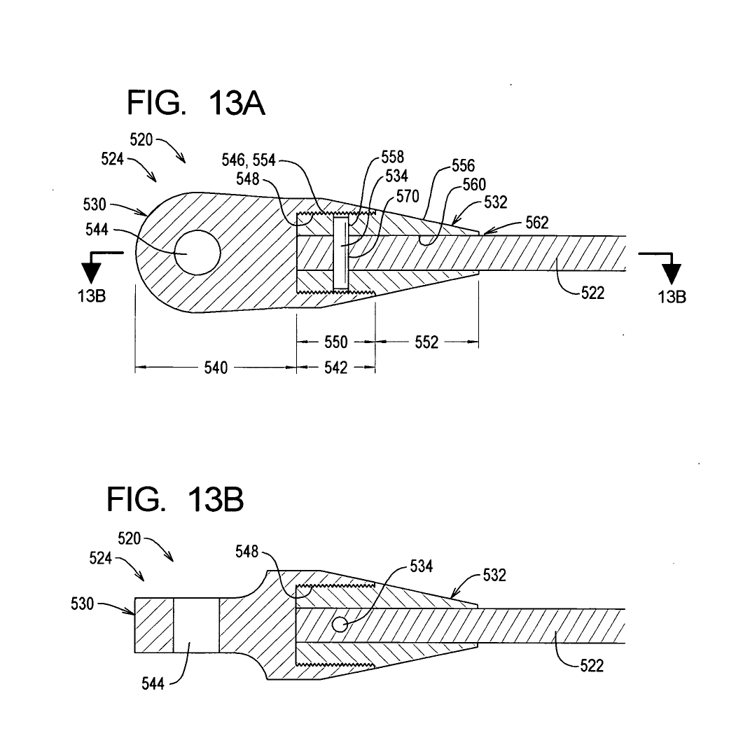

Turning now to FIGS. 13A and 13B of the drawing, depicted therein is a sixth example terminated composite rope structure 520. The terminated composite rope structure 520 comprises a rope member 522 and a termination assembly 524. The termination assembly 524 comprises a distal termination member 530, a proximal termination member 532, and pin member 534.

The distal termination member 530 comprises a working portion 540 and a distal connecting portion 542. The example working portion 540 comprises an eyelet opening 544 that may be connected to a structural member (not shown). Again, the working portion 540 may take forms other than that depicted in the drawing depending upon the environment in which the composite rope structure 520 is used and/or the nature of the structural member to which the composite rope structure 520 is to be attached. The example distal connecting portion 542 comprises a distal threaded surface 546. The example distal threaded surface 546 is an internal surface surrounding a cavity 548.

The example proximal connection member 532 comprises a proximal connecting portion 550 and a transition portion 552. The proximal connecting portion 550 comprises a proximal threaded surface 554, a transition surface 556, and a first pin opening 558. The proximal threaded surface 554 and transition surface 556 are external surfaces of the proximal connection member 532. The proximal connecting member 532 further comprises a shaft surface 560. The shaft surface 560 of the example proximal connecting member 532 is an internal surface that defines a proximal opening 562.

Formed in the rope member 522 is a second pin opening 570. The second pin opening 570 is preformed on the rope member 522. In particular, the second pin opening 570 is formed, and at least the portion of the rope member 522 in which the second pin opening 570 is formed is at least partly cured such that the second pin opening 570 holds its shape.

To form the terminated composite rope structure 520, the rope member is inserted into the proximal opening 562 until the first pin opening 558 is aligned with the second pin opening 570. The pin member 534 is then inserted through the aligned pin openings 558 and 570 to secure the rope member 522 to the proximal termination member 532. The distal termination member 530 is then displaced such that the distal threaded surface 546 engages the first proximal threaded surface 554 to connect the distal termination member 530 to the proximal termination member 532.

The present invention may be embodied in forms other than those described above. The scope of the present invention should thus be determined by the claims appended hereto and not the foregoing detailed description of examples of the invention.

What is claimed is:

1. A terminated composite rope structure comprising:
a composite rope structure comprising an end; and
a termination assembly for connecting the end of the composite rope structure to a structural member, comprising
a distal connection member defining a first threaded surface and a working portion, where the working portion is adapted to be connected to the structure, and
a proximal connection member defining a second threaded surface, an internal surface, and a proximal opening; wherein
the first and second threaded surfaces are configured to engage each other to detachably attach the distal connection member and the proximal connection member; and
the internal surface of the proximal connection member is configured to engage the end of the composite rope structure to secure the composite rope structure relative to the proximal connection member.

2. A terminated composite rope structure as recited in claim 1, in which the internal surface of the proximal connection member is threaded.

3. A terminated composite rope structure as recited in claim 1, in which:
the end of the composite rope structure defines a head portion; and
the internal surface of the proximal connection member defines a bearing surface; wherein
the bearing surface engages the head portion of the end of the composite rope structure to inhibit movement of the rope structure out of the proximal opening relative to the proximal connection member.

4. A terminated composite rope structure as recited in claim 3, in which the bearing surface is canted.

5. A terminated composite rope structure as recited in claim 3, in which:
the bearing surface defines a proximal radial surface; and
the composite rope structure defines a rope radial surface; wherein
the rope radial surface is sized and dimensioned to engage the proximal radial surface.

6. A terminated composite rope structure as recited in claim 1, in which the end of the composite rope structure defines at least one fin portion defining the bearing surface.

7. A terminated composite rope structure as recited in claim 1, in which the end of the composite rope structure defines a plurality of fin portions, where each of the fin portions defines a bearing surface.

8. A terminated composite rope structure as recited in claim 1, further comprising a pin member, wherein:
a pin opening is formed in the proximal connection member; and
the pin member extends through the pin opening and engages the composite rope structure to inhibit movement of the rope structure out of the proximal opening relative to the proximal connection member.

9. A terminated composite rope structure as recited in claim 1, further comprising an internal termination member, wherein:
the proximal opening of the proximal connection member is sized and dimensioned to receive the internal termination member and at least a portion of the end of the composite rope structure; and
the proximal connection member engages the portion of the end of the composite rope structure to inhibit movement of the rope structure out of the proximal opening relative to the proximal connection member.

10. A terminated composite rope structure as recited in claim 1, in which the internal termination member defines an engaging surface and an internal opening, wherein:
a first portion of the composite rope structure extends through the internal opening; and
a second portion of the composite rope structure is arranged between the engaging surface and the internal surface of the proximal connection member.

11. A terminated composite rope structure as recited in claim 1, in which at least a portion of the end of the composite rope structure is at least partly cured.

12. A method of terminating a composite rope structure comprising the steps of:
providing a distal connection member defining a first threaded surface and a working portion, where the working portion is adapted to be connected to the structure;
providing a proximal connection member defining a second threaded surface, an internal surface, and a proximal opening;
arranging an end portion of the composite rope structure within the proximal opening of the proximal connection member, where the internal surface of the proximal connection member is configured to engage the end of the composite rope structure to secure the composite rope structure relative to the proximal connection member;
engaging the first and second threaded surfaces to detachably attach the distal connection member and the proximal connection member.

13. A method as recited in claim 12, further comprising the step of at least partly curing at least a portion of the end of the composite rope structure.

14. A method as recited in claim 13, further comprising the step of at least partly curing at least a portion of the end of the composite rope structure prior to the step of arranging the end portion of the composite rope structure within the proximal opening of the proximal connection member.

15. A method as recited in claim 12, in which the step of providing the proximal connection member comprises the step of threading the internal surface of the proximal connection member.

16. A method as recited in claim 12, further comprising the steps of:
forming a head portion on the end of the composite rope structure;
forming the internal surface of the proximal connection member to define a bearing surface; and
engaging the bearing surface with the head portion of the end of the composite rope structure to inhibit movement of the rope structure out of the proximal opening relative to the proximal connection member.

17. A method as recited in claim 16, further comprising the steps of forming at least one fin portion on the end of the composite rope structure, where the at least one fin portion defines the bearing surface.

18. A method as recited in claim 12, further comprising the steps of:
providing a pin member;
forming a pin opening in the proximal connection member; and
extending the pin member through the pin opening such that the pin member engages the proximal connection member and the composite rope structure to inhibit movement of the rope structure out of the proximal opening relative to the proximal connection member.

19. A method as recited in claim 12, further comprising the steps of:
providing an internal termination member;
configuring the proximal opening of the proximal connection member to receive the internal termination member and at least a portion of the end of the composite rope structure; and
arranging at least a portion of the internal termination member within the proximal opening such that the proximal connection member engages the portion of the end of the composite rope structure to inhibit movement of the rope structure out of the proximal opening relative to the proximal connection member.

20. A method as recited in claim 19, in which the step of providing the internal termination member comprises the step of forming an engaging surface and an internal opening, further comprising the steps of:
extending a first portion of the composite rope structure within the internal opening; and
arranging a second portion of the composite rope structure between the engaging surface of the internal termination member and the internal surface of the proximal connection member.

21. A termination assembly for facilitating connection of a composite rope structure comprising an end to a structure, the termination assembly comprising:
a distal connection member defining a first threaded surface and a working portion, where the working portion is adapted to be connected to the structure, and
a proximal connection member defining a second threaded surface, an internal surface, and a proximal opening; wherein
the first and second threaded surfaces are configured to engage each other to detachably attach the distal connection member and the proximal connection member; and
the internal surface of the proximal connection member is configured to engage the end of the composite rope structure to secure the composite rope structure relative to the proximal connection member.

22. A termination assembly as recited in claim 21, in which the internal surface of the proximal connection member is threaded.

23. A termination assembly as recited in claim 21, in which:
the end of the composite rope structure defines a head portion; and
the internal surface of the proximal connection member defines a bearing surface; wherein
the bearing surface engages the head portion of the end of the composite rope structure to inhibit movement of the rope structure out of the proximal opening relative to the proximal connection member.

24. A termination assembly as recited in claim 23, in which the bearing surface is canted.

25. A termination assembly as recited in claim 23, in which:
the bearing surface defines a proximal radial surface; and
the composite rope structure defines a rope radial surface; wherein
the rope radial surface is sized and dimensioned to engage the proximal radial surface.

26. A termination assembly as recited in claim 21, in which the end of the composite rope structure defines at least one fin portion defining the bearing surface.

27. A termination assembly as recited in claim 21, in which the end of the composite rope structure defines a plurality of fin portions, where each of the fin portions defines a bearing surface.

28. A termination assembly as recited in claim 21, further comprising a pin member, wherein:
a pin opening is formed in the proximal connection member; and
the pin member extends through the pin opening and engages the composite rope structure to inhibit movement of the rope structure out of the proximal opening relative to the proximal connection member.

29. A termination assembly as recited in claim 21, further comprising an internal termination member, wherein:
the proximal opening of the proximal connection member is sized and dimensioned to receive the internal termination member and at least a portion of the end of the composite rope structure; and
the proximal connection member engages the portion of the end of the composite rope structure to inhibit movement of the rope structure out of the proximal opening relative to the proximal connection member.

30. A termination assembly as recited in claim 21, in which the internal termination member defines an engaging surface and an internal opening, wherein:
a first portion of the composite rope structure extends through the internal opening; and
a second portion of the composite rope structure is arranged between the engaging surface and the internal surface of the proximal connection member.

31. A termination assembly as recited in claim 21, in which at least a portion of the end of the composite rope structure is at least partly cured.
